(19) United States
(12) Patent Application Publication
(10) Pub. No.: US 2006/0022924 A1
(43) Pub. Date: Feb. 2, 2006

(54) Head drum assembly for magnetic recording and reproducing apparatus

(75) Inventors: Myoung-joon Kim, Suwon-si (KR); Chung-hum Baik, Suwon-si (KR); Bong-joo Kim, Suwon-si (KR); Jun-young Kim, Suwon-si (KR); Young-ho Cho, Suwon-si (KR); Jae-kab Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/143,592

(22) Filed: Jun. 3, 2005

(30) Foreign Application Priority Data
Jul. 29, 2004 (KR) 2004-59544

(51) Int. Cl. G09G 3/36

(52) U.S. Cl. 345/89

(57) ABSTRACT

An apparatus and method for compensating a gray-scale CCT in an LCD are provided. In the apparatus, a camera captures an external image, a memory stores the captured image and other image data, and a video processor compensates the correlated color temperature (CCT) of the image received from the camera and the image data read from the memory according to a gray-scale CCT compensation control signal, and outputs a compensated RGB signal. A display receives the compensated RGB signal and displays the image on the LCD according to the RGB colors. A controller controls the video processor by the gray-scale CCT compensation control signal for the image data received from the camera and the memory.

### PRIORITY

This application claims priority under 35 U.S.C. § 119(a) to an application entitled “Apparatus and Method for Compensating Correlated Color Temperature of Gray Scale in LCD” filed in the Korean Intellectual Property Office on Jun. 3, 2004 and assigned Serial No. 2004-40555, the entire contents of which are expressly incorporated herein by reference.

### BACKGROUND OF THE INVENTION

1. Field of the Invention

The present invention relates generally to a liquid crystal display (LCD). More particularly, the present invention relates to a gray-scale correlated color temperature (CCT) compensating apparatus and method in an LCD, for maintaining a constant CCT according to a variation of a gray-scale input value by controlling a red, green, blue (RGB) value.

2. Description of the Related Art

LCDs are widely used in display devices due to their excellent characteristics of thinness, lightweight, high image quality, high resolution, and low power consumption. These display devices include a personal computer (PC) monitors and TV monitors. Yet, the existing conventional LCD does not match the performance of existing cathode ray tubes (CRTs) in color reproducibility because of the physical and electro-optical properties of the liquid crystal.

The CRT typically provides accurate color reproducibility because there is little change in RGB chromaticity coordinates and gray-scale CCT in regards to the change of an input RGB value, while the LCD experiences a considerable change according to an input value due to its nature. This considerable change in RGB chromaticity coordinates and gray-scale CCT makes accurate color reproduction in LCD devices challenging. The color temperature of a light source is defined as the value of the absolute temperature of a black body (an ideal radiator) when the black body's chromaticity matches that of the light source. The CCT of the light source describes its color, and the CCT is a color temperature closest on the locus of the black body.

FIGS. 1A and 1B illustrate the chromaticity coordinates of RGB and gray in a conventional LCD. Referring to FIGS. 1A and 1B, changes in the gray-scale chromaticity coordinates are shown according to the change of an input digital value ranging from white (R{255}, G{255}, B{255}) to black (R{0}, G{0}, B{0}). For a higher gray scale, the chromaticity shifts to blue. Also, when the input digital value is increased to achieve white (R{255}, G{255}, B{255}), it is shown that the RGB chromaticity coordinates are distorted.

FIGS. 2A and 2B are diagrams illustrating the RGB characteristics of the conventional LCD. In FIG. 2A, curves (a) to (d) represent the luminance [cd/m²] of white, red, green, and blue, respectively. The sum of the curves (a) to (d) in FIG. 2A is supposed to match a curve e representing the relative luminance [%] of white in FIG. 2B. However, an erroneous curve (f) results. As shown in FIGS. 3A and 3B, which illustrates CCTs according to digital inputs for a target CCT of 6500K and for a target CCT of 7500K, respectively, the gray-scale CCT increases as the input digital value decreases. Hence, a darker color has a bluish cast and the gray-scale CCT is above the target CCT values of 6500K and 7500K.

As a result, the conventional LCD suffers from considerable variations in the RGB chromaticity coordinates and the gray-scale CCT according to the change of an input RGB value, making correct color reproduction difficult.

### SUMMARY OF THE INVENTION

An object of the present invention is to substantially solve at least the above problems and/or disadvantages and to provide at least the advantages below. Accordingly, an object of the present invention is to provide a gray-scale CCT compensating apparatus and method for use in an LCD, for maintaining a constant CCT against the change of a gray-scale input value by adjusting the respective input digital values of RGB, to thereby achieve accurate color reproduction. The above object is achieved by providing an apparatus and method for compensating a gray-scale CCT in an LCD.

According to an embodiment of the present invention, the gray-scale CCT compensating apparatus comprises a camera that captures an external image, a memory that stores the captured image and other image data, and a video processor that compensates the CCT of the image received from the camera and the image data read from the memory according to a gray-scale CCT compensation control signal, and outputs a compensated RGB signal. The gray-scale CCT compensating apparatus according to an embodiment of the present invention further comprises a display that receives the compensated RGB signal and displays the image on the LCD according to the RGB colors, and a controller that controls the video processor according to the gray-scale CCT compensation control signal for the image data received from the camera and the memory.

According to an embodiment of the present invention, a gray-scale CCT compensating method is provided comprising converting a luminance signal Y and color difference signals Cr and Cb that correspond to an image to be displayed on the LCD into an RGB signal, adjusting the number of bits of the RGB signal to a predetermined bit number, compensating the adjusted RGB signal by increasing its R signal value and decreasing its B signal value of the adjusted RGB signal with respect to its G signal value, and displaying the resultant image on the LCD according to the compensated RGB value.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B are chromaticity diagrams illustrating the chromaticity coordinates of RGB and gray in a conventional LCD;

FIGS. 2A and 2B are diagrams illustrating the RGB luminance characteristics of the conventional LCD;

FIGS. 3A and 3B are diagrams illustrating CCT versus digital input at target CCTs of 6500K and 7500K in the conventional LCD, respectively;

FIG. 4 is a block diagram of a portable terminal to which a gray-scale LCD CCT compensating apparatus is applied according to an embodiment of the present invention;

FIG. 5 is a block diagram of a video processor illustrated in FIG. 4;

FIG. 6 is a block diagram of a CCT compensator illustrated in FIG. 5;

FIG. 7 is a flowchart illustrating a gray-scale LCD CCT compensating method according to an embodiment of the present invention;

FIGS. 8A and 8B are look-up tables (LUTs) at target CCTs of 6500K and 7500K;

FIG. 9 illustrates LUT curves for use in the gray-scale CCT compensation according to an embodiment of the present invention;

FIG. 10 illustrates the gray-scale LCD CCT compensation considering gamma characteristic according to an embodiment of the present invention;

FIGS. 11A and 11B are chromaticity diagrams illustrating the chromaticity coordinates of grays after gray-scale CCT compensation at the target CCTs, 6500K and 7500K, respectively according to an embodiment of the present invention; and

FIGS. 12A and 12B are diagrams illustrating CCT versus RGB input at the target CCTs, 6500K and 7500K, respectively according to an embodiment of the present invention.

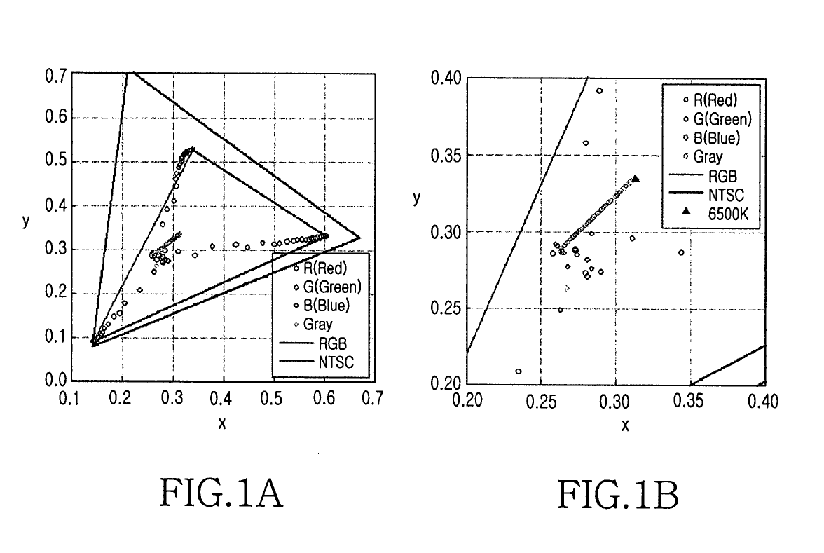

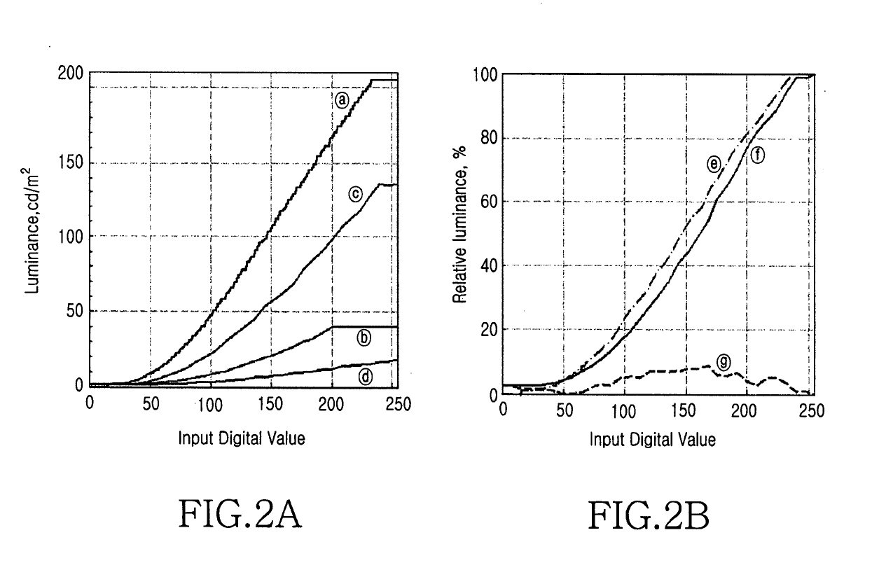

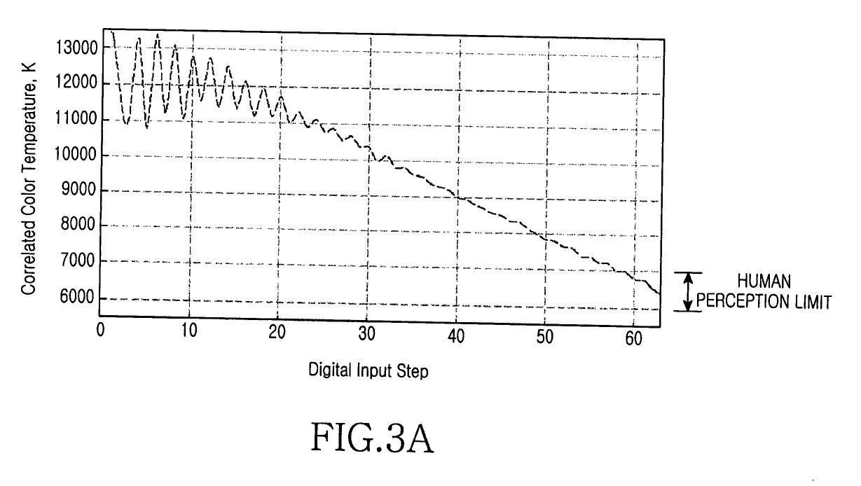

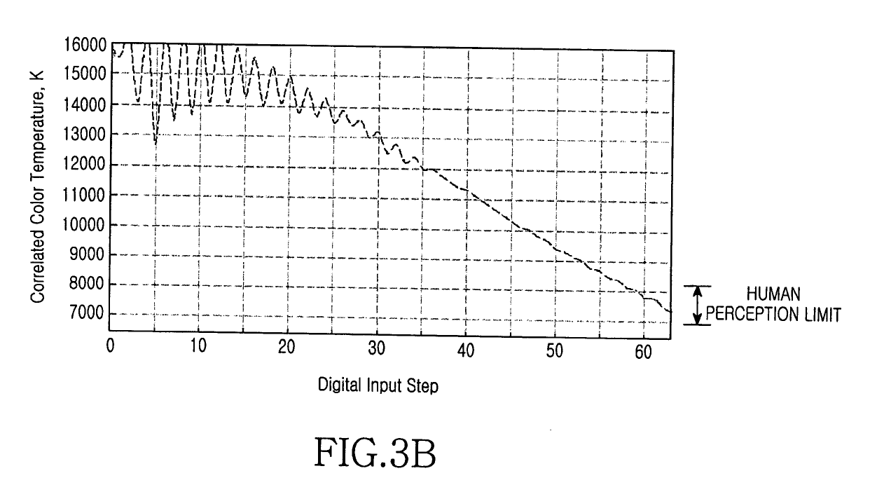

### DETAILED DESCRIPTION OF THE EXEMPLARY EMBODIMENTS

Exemplary embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

According to an embodiment of the present invention, an input digital RGB value is adjusted so that a gray-scale CCT falls into a range of 6500 to 8000K. Embodiments of the present invention will be described below in the context of a portable terminal which is equipped with an LCD. As one skilled in the art of the present invention can appreciate, however, such an exemplary discussion is not intended to be limiting. The embodiments of the present invention, including the apparatus and methods thereof, can be applied to many different devices, which are too numerous to list herein.

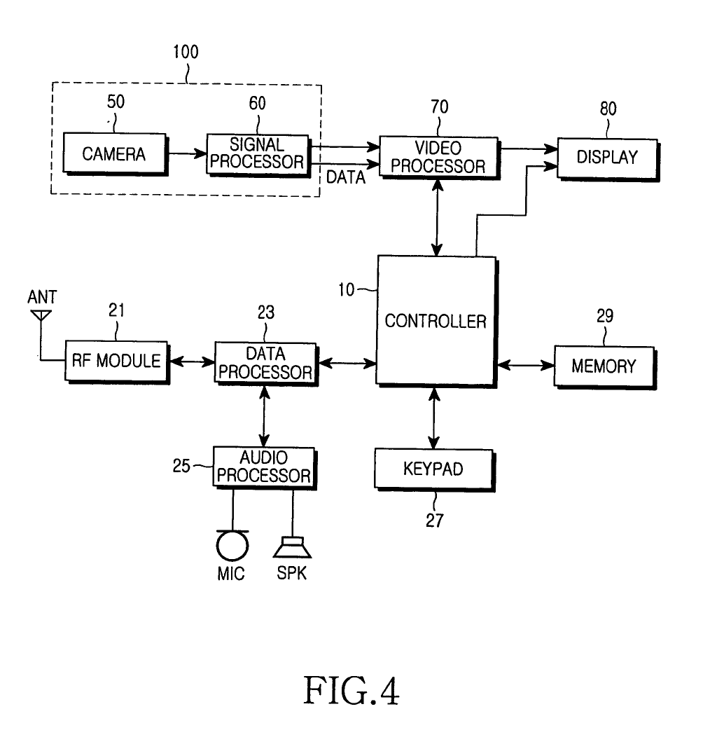

FIG. 4 is a block diagram of a portable terminal in which a gray-scale LCD CCT compensating apparatus according to an embodiment of the present invention can be applied. The portable terminal, according to an exemplary embodiment, can be a mobile phone. Referring to FIG. 4, a radio frequency (RF) module 21 carries out communications for the portable terminal. The RF module 21 includes an RF transmitter for upconverting and amplifying a transmission signal, and an RF receiver for low-noise amplifying and downconverting a received signal.

The portable terminal further comprises a data processor 23 that has a transmitter for encoding and modulating the transmission signal, and a receiver for demodulating and decoding the received signal. The data processor 23 can be configured to have a MODEM and a CODEC. The CODEC is composed of a data CODEC for processing packet data and an audio CODEC for processing an audio signal.

The portable terminal according to an embodiment of the present invention also comprises an audio processor 25 that reproduces the audio signal received from the data processor 23, or transmits a transmission audio signal generated from a microphone (MIC) to the data processor 23. The audio processor 25 also converts audio data received from the data processor 23 to an audible sound and outputs it through a speaker (SPK). The audio processor 25 converts an audio signal received from the microphone to audio data and outputs it to the data processor 23.

The portable terminal according to an embodiment of the present invention further comprises a keypad 27 that has alphanumeric keys for entering digits and characters and function keys for setting functions. A memory 29 can have a program memory and a data memory. The program memory portion of the memory 29 stores programs for controlling the general operation of the portable terminal, and programs for controlling input digital RGB values to control the change of a CCT in relation to the change of the gray-scale input value without degrading the properties of the display 80 including CCT, gamma, luminance, and contrast ratio according to an embodiment of the present invention. The data memory portion of the memory 29 temporarily stores data generated during execution of the programs.

A controller 10 in the portable terminal according to an embodiment of the present invention provides overall control to the portable terminal. The controller 10 can incorporate the data processor 23 thereinto. According to an embodiment of the present invention, the controller 10 controls the digital RGB values to compensate for the change of the CCT according to the change of the gray-scale input value. Also, the controller 10 maintains the CCT using a look-up-table (LUT) with an improved gray scale for the RGB values according to an embodiment of the present invention.

The portable terminal according to an embodiment of the present invention also comprises a camera 50 that captures video data. The camera 50 is provided with a camera sensor for converting a captured optical signal to an electrical signal. The camera sensor can be a charge coupled device (CCD) sensor, as is well known to those skilled in the art of the present invention. The portable terminal further comprises a signal processor 60 that converts the video signal received from the camera 50 into an image signal. The signal processor 60 can be implemented as a digital signal processor (DSP). In an exemplary embodiment of the present invention, the signal processor 60 converts an electrical signal to a video signal according to a sampling period, and outputs the video signal in a Bayer pattern that allows estimation of missing pixel information using neighboring pixels for each pixel. The camera 50 and the signal processor 60 collectively form a camera module 100.

A video processor 70 of the portable terminal generates display data by which the video signal received from the signal processor 60 is displayed. The video processor 70 outputs a video signal received under the control of the controller or video data captured by the camera 50 in the form suitable for a display 80. The video processor 70 also compresses and decompresses the video data. According to an embodiment of the present invention, the video processor 70 outputs the video data by controlling an input digital RGB value and thus compensating the change of the CCT caused by the change of the gray-scale input value. The video processor 70 according to an embodiment of the present invention also increases an input R value and decreases an input B value with respect to a G value in the input digital value so that the CCT falls in the vicinity of 6500K or 7500K, while maintaining the gray-scale luminance of the input digital value constant.

The portable terminal according to an embodiment of the present invention further comprises a display 80 that displays messages generated during executing programs under the control of the controller 10. The display 80 displays the video signal received from the video processor 70 on a screen in a camera mode and displays user data received from the controller 10. The user data is displayed as icons representing battery status, reception rate, bell/vibration, and so on. Also, the display 80 displays display data in tricolor (RGB) of which the CCT change caused by the change of the gray-scale input has been compensated for according to an embodiment of the present invention. The display 80 can be composed of an LCD. In an exemplary embodiment of the present invention, the display 80 includes an LCD controller, a memory for storing video data, and an LCD. If the LCD is implemented as a touch screen, the keypad 27 and the LCD can serve as an input portion.

In operation, if a user dials through the keypad 27 and sets an origination mode, the controller 10 processes dialing information through the data processor 23, converts the processed information to an RF signal through the RF module 21, and outputs the RF signal. When the other party generates a response signal, the controller 10 senses the response through the RF module 21 and the data processor 23. A voice communication path is established through the audio processor and the user converses with the other party. In a termination mode, the controller 10 senses the termination mode through the data processor 23 and generates a ring signal through the audio processor 25. If the user answers, the controller 10 senses the response and the voice communication path is established through the audio processor, to thereby allow the user to converse. While the origination and termination modes have been described in the context of voice communications, packet and video data communications can also be carried out. In an idle mode when text communications are carried out, the controller 10 displays text data processed by the data processor 23 on the display 80.

The portable terminal can capture an object or surroundings and display or transmit the captured image. The camera 50 is, in an exemplary embodiment of the present invention, built in the portable terminal or connected to a predetermined position outside the portable terminal. The camera 50 can therefore be built-in or used as an external device. The camera 50 can use a CCD sensor. A captured image is converted to an electrical signal in the internal CCD sensor and provided to the signal processor 60. The signal processor 60 converts the video signal to digital video data and provides the digital video data to the video processor 70.

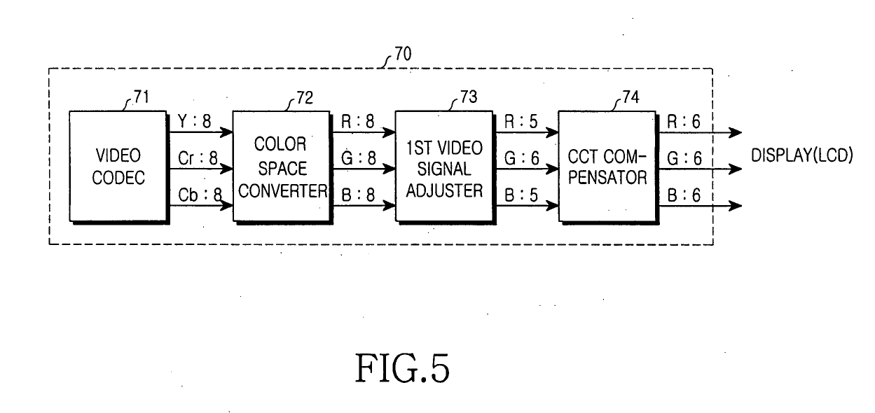

Regarding compensation of RGB chromaticity coordinates and a gray-scale CCT in the portable terminal according to an embodiment of the present invention, an image captured through the camera 50 is converted to a video signal through the signal processor 60 and the video processor 70 under the control of the controller 10. The input digital RGB value is adjusted using an LUT having adjusted RGB values to compensate for a CCT change and thus achieve a constant CCT. The captured image is encoded in the video processor 70 under the control of the controller 10 and can be stored in the memory 29. The controller 10 then reads the video data and display data according to a menu and a mode and outputs it to the video processor. The video processor 70 adjusts the RGB values of the video data using the LUT. The display 80 accurately reproduces the colors of the image data received from the video processor 70. The structure of the video processor 70 is illustrated in detail in FIG. 5.

Referring to FIG. 5, a video CODEC 71 according to an embodiment of the present invention encodes video data captured by the camera 50 in, for example, either MPEG or JPEG format, and outputs a digital luminance signal Y and color difference signals Cr and Cb, each in 8 bits. A color space converter 72 converts the signals Y, Cr, and Cb to a 24-bit RGB signal (R:8, G:8, B:8). A first video signal adjuster 73 deletes 3 bits starting with the least significant bit (LSB) from each of the R and B signals and 2 bits starting with the LSB from the B signal. Bit reduction is performed because of a limitation in processing a certain number of bits for an image. In this case, since G provides luminance information, it gets one more bit than R and B. Thus, the resulting RGB bits are 5 bits for R, 6 bits for G and 5 bits for B. The output of the first video signal adjuster 73 is provided to a CCT compensator 74.

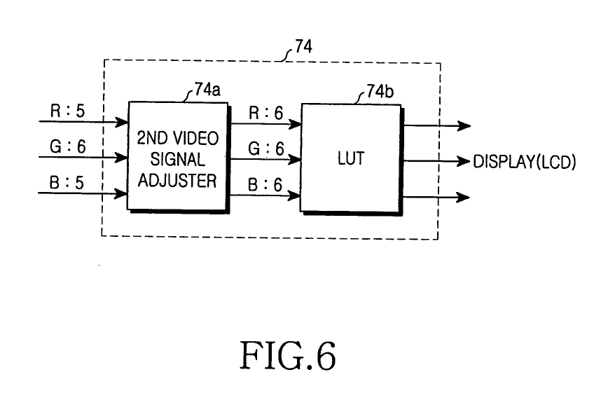

The CCT compensator 74 is illustrated in detail in FIG. 6. Referring to FIG. 6, a second video signal adjuster 74a adjusts the bit number of the RGB signal, R:5, G:6, B:5 to R:6, G:6, B:6 in order to achieve a constant CCT, while maintaining the original luminance value. The bit number of G is kept constant and 1 bit is added as the LSB for each of the R and B colors.

An LUT 74b sequentially receives the RGB signal from the second video signal adjuster 74a and outputs an adjusted 6 RGB bit word for the received RGB signal. The LUT is composed of preset RGBs (R:6, G:6, B:6) that are mapped to corresponding gray-scale chromaticity coordinates, and input RGB values are adjusted to those that lead to a target CCT value. The adjusted RGB bits are provided to the display 80.

The CCT compensator 74 illustrated in FIG. 6 is included in the controller 10. It can also be configured to generate an RGB signal (R:6, G:6, B:6) from an RGB signal (R:5, G:6, B:5) received from the first video signal adjuster 73 using the LUT 74b.

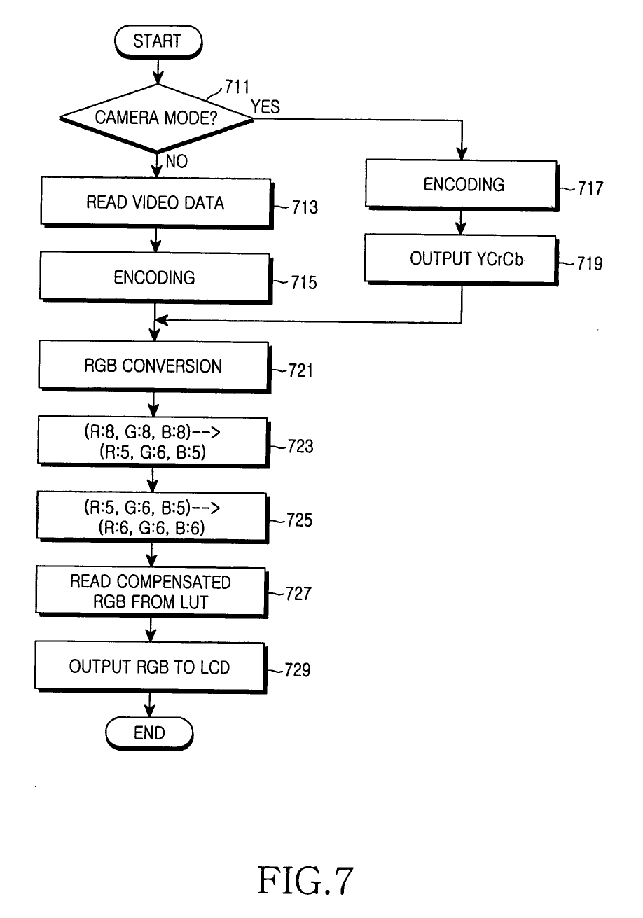

FIG. 7 is a flowchart illustrating the gray-scale LCD CCT compensating method according to an embodiment of the present invention. Referring to FIG. 7, the controller 10 determines whether a camera mode has been set in decision step 711. If the camera mode has not been set (“No” path from decision step 711), the controller 713 senses the set mode and reads video data from the memory 29 according to the mode in step 713. In step 715, the controller 10 encodes the video data and outputs a luminance signal Y and color difference signals Cr and Cb.

In the case of the camera mode (“Yes” path from decision step 711), the controller 10 encodes the video signal captured by the camera 50 in step 717 and outputs a luminance signal Y and color difference signals Cr and Cb in correspondence with the coded video signal in step 719. Upon user selection, the video data of the captured image is encoded and stored in the memory 29 under the control of the controller 10. This video data is later read from the memory 29 and processed in steps 711 to 715 for CCT compensation in the mode other than the camera mode.

After step 715 or 719, the controller 10 converts the video signal YCrCb to an RGB signal in step 721. The RGB conversion is performed by a general mathematical formula, well known to those of ordinary skill in the art, and thus its description is not provided here. In step 723, the controller 10 deletes 3 bits starting with the LSB from each of the 8-bit R signal and the 8-bit B signal, and 2 bits starting with the LSB from the 8-bit G signal.

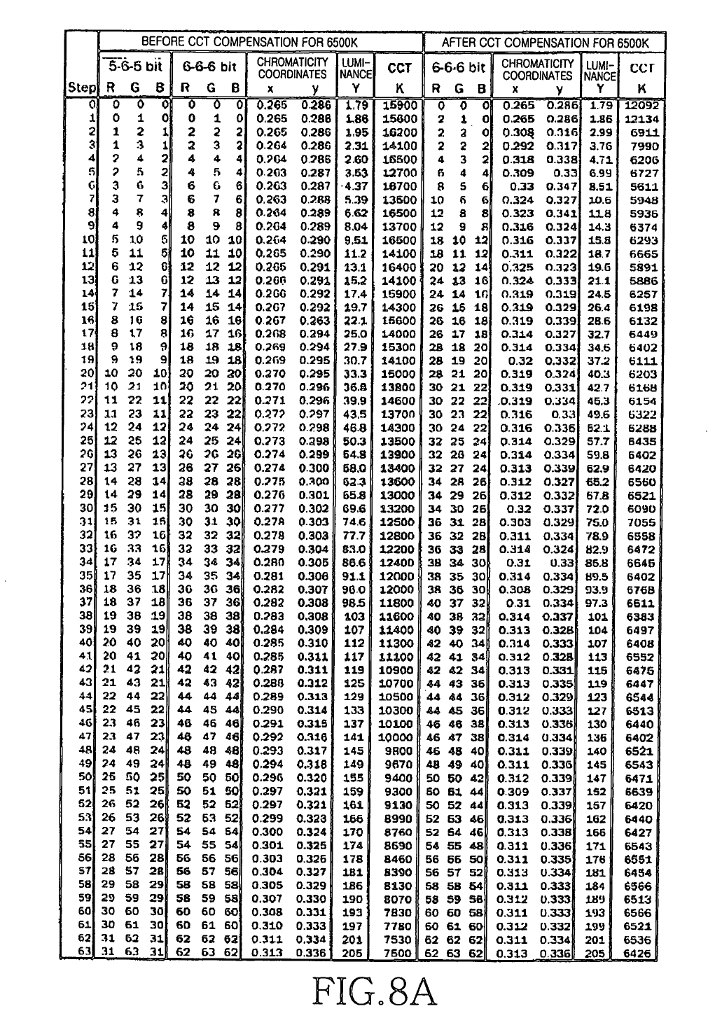

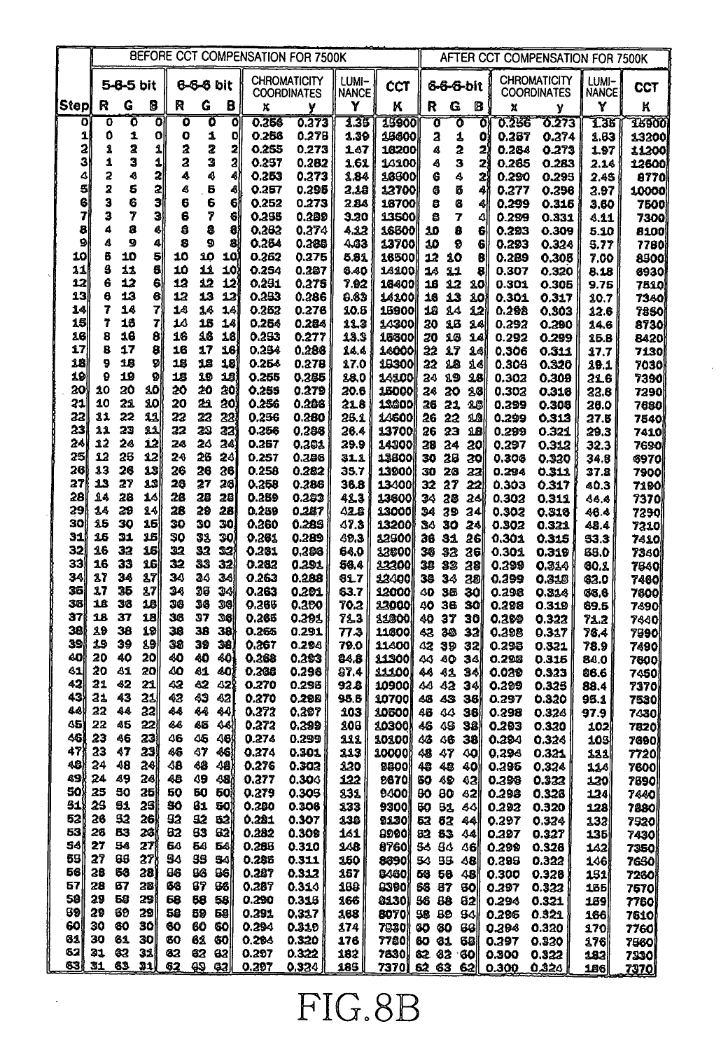

The controller 10 adjusts the RGB signal (R:5, G:6, B:5) to an RGB signal (R:6, G:6, B:6) in step 725. The 6 most significant bits (MSB) are kept for the G signal and one more bit is added as the LSB for each of the R and B signals. In step 727, the controller 10 reads an adjusted RGB value for the bit-adjusted RGB signal from the LUT 74b. The LUT 74b varies with a target CCT. If the target CCT is 6500K, the LUT 74b as illustrated in FIG. 8A is used. If the target CCT is 7500K, the LUT 74b as illustrated in FIG. 8B is used. In step 729, the RGB values are output to the display 80.

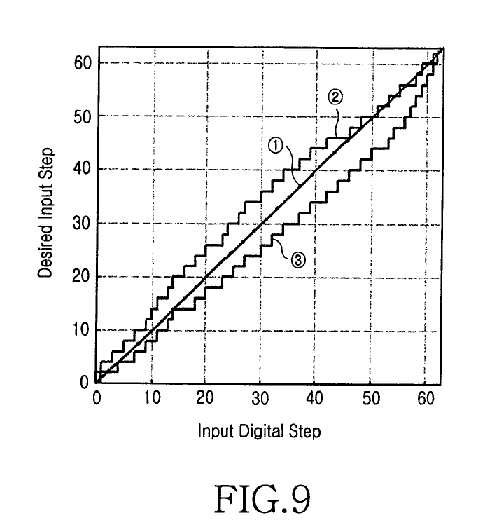

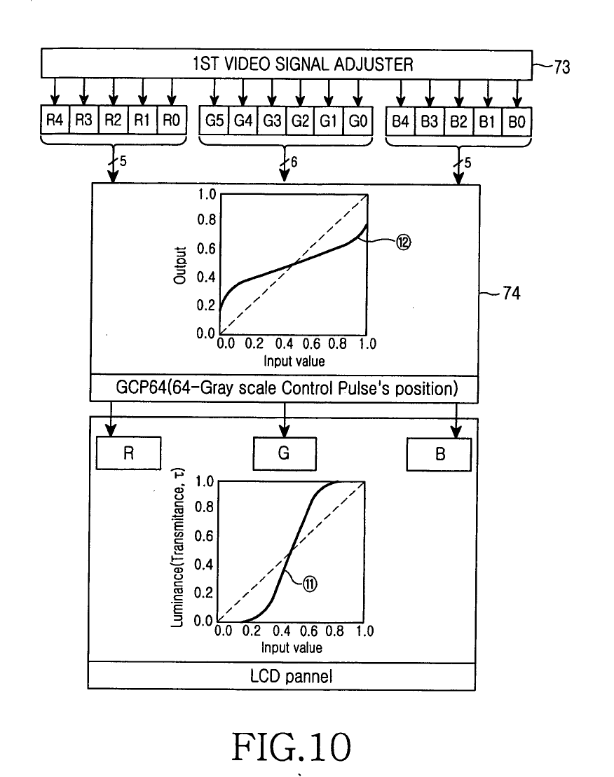

As shown in FIGS. 8A and 8B, the R value is adjusted to increase with respect to the G value, and the B value is adjusted to decrease with respect to the G value, and the CCT is close to 6500K or 7500K. The RGB chromaticity coordinates are located in almost one area. The characteristics of the LUT 74b used in the gray-scale CCT compensation are illustrated in the form of curves in FIG. 9. It is noted from FIG. 9 that the R value increases as indicated by a curve (2) and the B value decreases as indicated by a curve (3) with respect to the G value indicated by a curve (1). In FIG. 10, it is shown that the LUT 74b considers a curve (12) to compensate for a gamma characteristic curve (11) generated from the LCD itself.

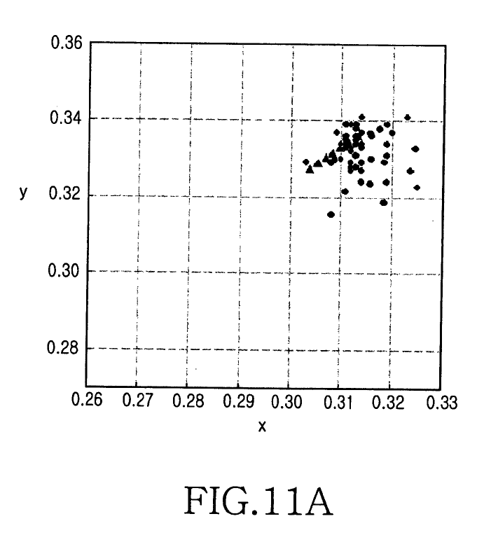

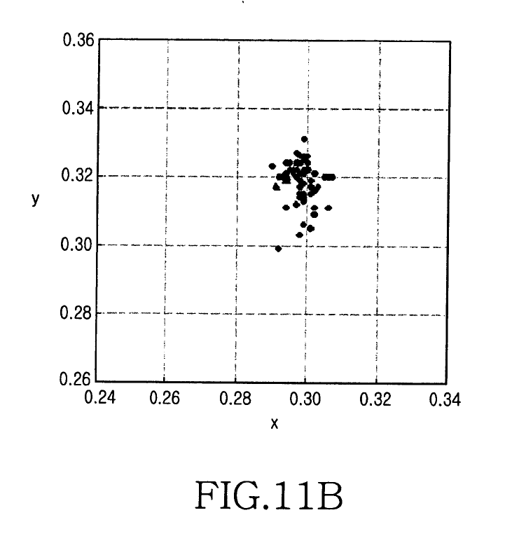

The effects of the gray-scale CCT compensation according to the embodiment of the present invention are apparent from FIGS. 11A and 11B. FIGS. 11A and 11B are chromaticity diagrams illustrating the chromaticity coordinates of grays after the gray-scale CCT compensation at the target CCTs, 6500K and 7500K, respectively in relation to the LUTs of FIGS. 8A and 8B according to an embodiment of the present invention. Concentration of the chromaticity coordinates in a certain range implies a constant CCT.

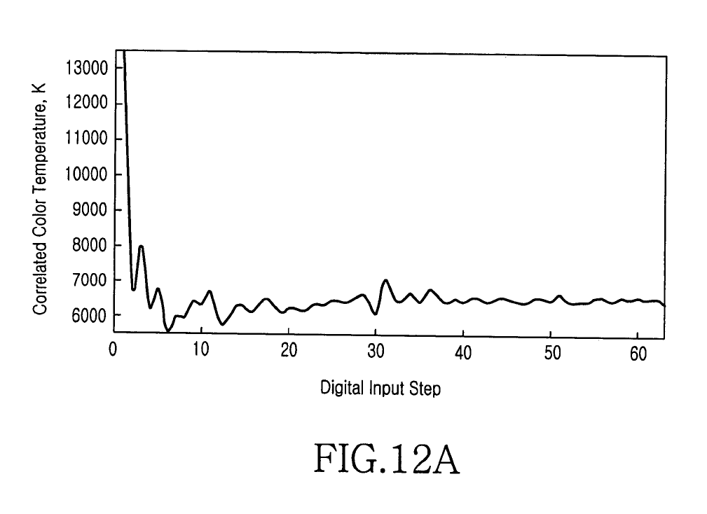

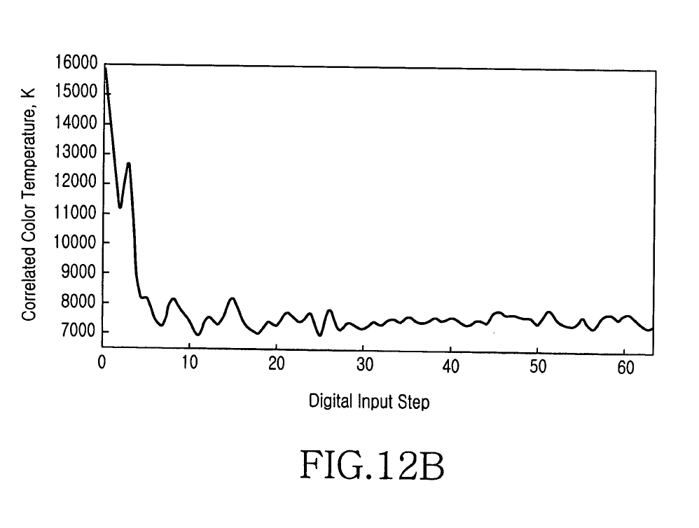

In step 729, the controller 10 outputs the RGB value read from the LUT 74b to the display 80. The display 80 accurately reproduces colors by the input RGB value of video data, of which the gray-scale CCT was compensated by the LUT 74b in the camera mode or the non-camera mode. This is shown from FIGS. 12A and 12B. FIGS. 12A and 12B are diagrams illustrating CCT versus RGB input at the target CCTs, 6500K and 7500K, respectively according to an embodiment of the present invention. The reason for not compensating a dark area with a large CCT difference in FIGS. 12A and 12B is that the human's color perception ability decreases with lower brightness and thus the color change is scarcely perceivable.

Therefore, the gray-scale LCD CCT compensating method according to an embodiment of the present invention adjusts an input digital RGB value using a LUT so that the gray-scale CCT falls into a range between 6500K and 8000K. Hence, the gray-scale luminance is kept constant before and after the compensation and the CCT is compensated to be almost constant against a change in chromaticity coordinates and input gray-scale RGB values.

As described above, the embodiments of the present invention adjust respective digital RGB values and displays the adjusted RGB values on an LCD, thereby maintaining the CCT constant against the change of the gray-scale input value and allowing accurate color reproduction through the LCD. Thus, a user can enjoy more realistic images on the LCD.

While the invention has been shown and described with reference to a certain exemplary embodiments thereof, it will be understood by those skilled in the art that various changes in form and details may be made therein without departing from the spirit and scope of the invention as defined by the appended claims.

What is claimed is:

1. An apparatus for compensating a gray-scale correlated color temperature (CCT) in a liquid crystal display (CLD), comprising:
a camera for capturing an external image;
a memory for storing the captured image and other image data;
a video processor for compensating the CCT of the image received from the camera and the image data read from the memory according to a gray-scale CCT compensation control signal, and outputting a compensated red, green and blue (RGB) signal;
a display for receiving the compensated RGB signal and displaying the image data on the LCD according to the RGB colors; and
a controller for controlling the video processor by the gray-scale CCT compensation control signal for the image data received from the camera and the memory.

2. The apparatus of claim 1, wherein the video processor comprises:
a video CODEC for encoding an image to be displayed on the LCD and outputting a luminance signal Y and color difference signals Cr and Cb corresponding to the encoded image;
a color space converter for converting the luminance signal Y and the color difference signals Cr and Cb to an RGB signal having a predetermined number of bits;
a first video signal adjuster for deleting a predetermined number of bits starting with the least significant bit (LSB) from the RGB signal and outputting a primarily bit number-adjusted RGB signal; and
a CCT compensator for increasing an R signal value of the primarily bit number-adjusted RGB signal and decreasing a B signal value of the primarily bit number-adjusted RGB signal with respect to a G signal value of the primarily bit number-adjusted RGB signal.

3. The apparatus of claim 2, wherein the CCT compensator comprises:
a second video signal adjuster for adding a predetermined number of bits before the LSB of the primarily bit number-adjusted RGB signal and outputting a secondarily bit number-adjusted RGB signal; and
a look-up table (LUT) for compensating the secondarily bit number-adjusted RGB signal so that the gray-scale luminance of the secondarily bit number-adjusted RGB signal is maintained and the CCT and gray-scale chromaticity coordinates of the secondarily bit number-adjusted RGB signal are kept in a predetermined range.

4. The apparatus of claim 3, wherein the second video signal adjuster adjusts the number of bits in the RGB signal from 5 bits for the R signal, 6 bits for the G signal, and 5 bits for the B signal to 6 bits for the R signal, 6 bits for the G signal, and 6 bits for the B signal.

5. The apparatus of claim 3, wherein the second video signal adjuster adds 1 bit to the LSB of each of the 5-bit R signal and the 5-bit B signal in the RGB signal.

6. The apparatus of claim 1, wherein the LUT has a pre-stored list of compensated RGB values mapped to outputs of the second video signal adjuster.

7. The apparatus of claim 6, wherein each of the R, G and B signals of a compensated RGB value has 6 bits.

8. The apparatus of claim 6, wherein the compensated RGB values in the LUT are set to a target gray-scale CCT range between 6000 and 8000K.

9. The apparatus of claim 1, wherein the video processor compensates the RGB signal for a target gray-scale CCT between 6000 and 8000K.

10. A method of compensating a gray-scale correlated color temperature (CCT) in a liquid crystal display (LCD), comprising:
converting a luminance signal Y and color difference signals Cr and Cb corresponding to an image to be displayed on the LCD to an RGB signal and adjusting the number of bits of the RGB signal to a predetermined bit number;
compensating the adjusted RGB signal by increasing an R signal value of the adjusted RGB signal and decreasing a B signal value of the adjusted RGB signal with respect to a G signal value of the adjusted RGB signal; and
displaying the image on the LCD according to the compensated RGB value.

11. The method of claim 10, wherein the RGB compensating step comprises:
compensating the RGB signal to maintain a gray-scale luminance value set before the compensation, and the CCT and gray-scale chromaticity coordinates are maintained in a predetermined range.

12. The method of claim 10, wherein the RGB signal adjusting step comprises:
deleting 3 bits starting with the LSB from each of an 8-bit R signal and an 8-bit B signal and 2 bits starting with the LSB from an 8-bit G signal in an RGB signal; and
adding 1 bit to the LSB of each of the 5-bit R signal and the 5-bit B signal in the RGB signal.

13. The method of claim 10, wherein the RGB compensating step comprises:
reading the compensated RGB value mapped to the adjusted RGB signal from a look-up table (LUT).

14. The method of claim 13, wherein each of the R, G and B signals of the compensated RGB value has 6 bits.

15. The method of claim 10, wherein the RGB compensating step comprises:
compensating the RGB signal for a target gray-scale CCT range between 6000 and 8000K.
